(19) United States
(12) Patent Application Publication
(10) Pub. No.: US 2005/0003845 A1
(43) Pub. Date: Jan. 6, 2005

(54) Fire detection system

(76) Inventor: Johnny Pollard, Table View (ZA)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/487,445

(22) PCT Filed: Jul. 25, 2002
(86) PCT No.: PCT/ZA02/00120

(30) Foreign Application Priority Data
Aug. 23, 2001 (ZA) 2001/6986

(51) Int. Cl. H04B 7/00; H04Q 7/20

(52) U.S. Cl. 455/521; 455/404.1; 455/404.2

(57) ABSTRACT

A fire detection system (10) for a building is disclosed which comprises a fire panel (12), a loop (16), and a plurality of fire detectors (14) on the loop. Each fire detector includes a transponder which enables the fire detector to communicate with asset tags (20) on assets (18.1, 18.2) distributed in the building. The tags can communicate with a number of tarnsponders whereby the tags' position in the building can be tracked.

### FIELD OF THE INVENTION

THIS INVENTION relates to a fire detection system, a fire detector for use in forming part of such a system, and a kit of parts including such a fire detector.

### BACKGROUND TO THE INVENTION

Most modern buildings are equipped with a fire detection system. Such a system conventionally includes a control panel located in, for example, a guard house or security office, fire detectors of various types distributed throughout the building and hardwiring between the panel and the detectors.

Theft of assets, particularly high value assets such as computers, from buildings is a major problem which causes significant losses to the occupants of the building.

The present invention seeks to take advantage of the communications network, the fire detection system, which is already in the building to inhibit theft of assets.

In some buildings, such as hospitals, it is desirable to know where to find key personnel. The present invention also seeks to take advantage of said network fro the purpose of tracking assets.

### BRIEF DESCRIPTION OF THE INVENTION

According to one aspect of the present invention there is provided a fire detection system which comprises a control panel, a plurality of distributed fire detectors, a communications network via which communication between the detectors and the control panel can take place, and an asset tagging transponder which is also linked to the control panel via said communications network.

Said asset tagging transponder can be a built-in part of, or otherwise associated with, one of the fire detectors. Preferably the system comprises a plurality of asset tagging transponders, each of said transponders being a built-in part of, or otherwise associated with, a corresponding one of the fire detectors.

In one form of the system it includes a plurality of asset tags each of which includes means for establishing a radio frequency communications link with said transponder.

In another form of the system it includes a plurality of asset tags each of which includes means for establishing a radio frequency communications link with at least one of said transponders. In this form of the system each asset tag can include means for establishing a radio frequency communications link with a plurality of said transponders whereby said transponders can track the location of the asset with which the tag is associated.

According to another aspect of the invention there is provided a kit which comprises a fire detector including an asset tagging transponder, and one or more asset tags, the asset tagging transponder being capable of communicating with the (or each) asset tag over a radio frequency communications link.

According to a further aspect of the present invention there is provided a fire detection system which comprises a control panel, a plurality of fire detectors distributed in the building which is to be protected, each fire detector incorporating an asset tagging transponder, a hard wired communications link between the fire detectors and the control panel over which communications between the panel and detectors can take place, and a plurality of asset tags on assets distributed in said building, each asset tag being in radio frequency communication with one of said transponders. In this system each asset tag can include means for enabling it to communicate with two or more transponders whereby the transponders can track the location of assets in said premises.

### BRIEF DESCRIPTION OF THE DRAWINGS

The invention will now be described in more detail, by way of example, with reference to the accompanying drawings.

In the drawings:

FIG. 1 is a schematic diagram of a fire detection system in accordance with the invention;

FIG. 2 is a block diagram of a fire detector forming part of the system;

FIG. 3 is a block diagram of one form of asset tag for use in the system, being an active asset tag; and

FIG. 4 is a block diagram of another form of asset tag for use in the system, being a passive asset tag.

### DETAILED DESCRIPTION OF THE DRAWINGS

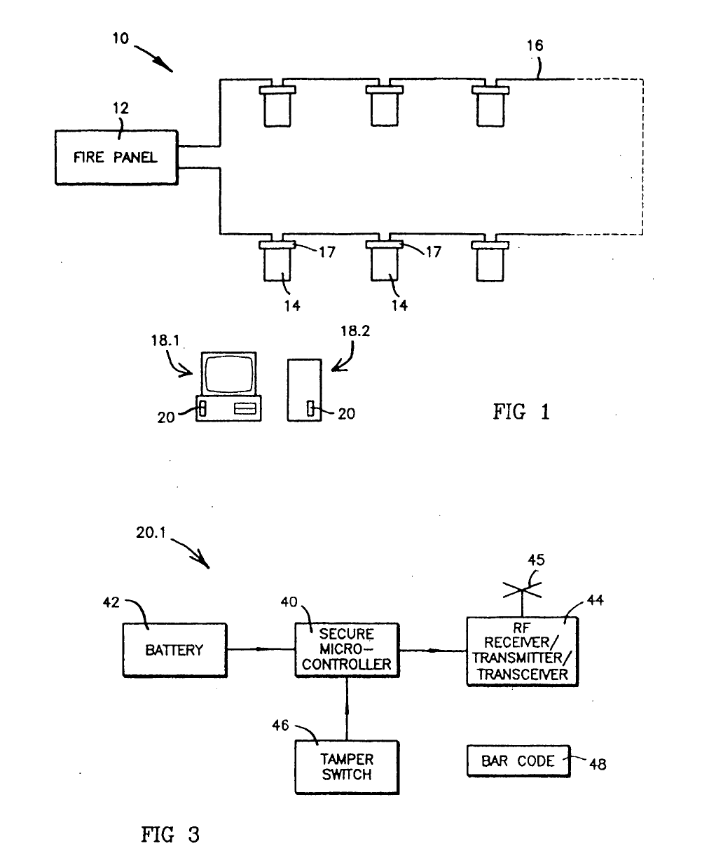

Referring first to FIG. 1, reference numeral 10 generally indicates an intelligent fire detection system which comprises a control or fire panel 12, also referred to as Control Indication Equipment (CIE), a plurality of fire detectors 14, and a communications link in the form of a wire loop 16 whereby the fire detectors are linked to the fire panel. The fire detectors 14 are distributed throughout a building or other premises being monitored by the system. The fire detectors 14 are such that they can be connected interchangeably to sockets 17 provided for this purpose in the wire loop 16. The fire panel 12, sockets 17, and the wire loop 16 can be of the conventional type and will therefore not be described here in greater detail. At least some of the fire detectors 14, however, are of a unique type and give the system an entirely new functionality. Although unique, they are interchangeable with conventional fire detectors for which the sockets 17 that receive them have been designed.

As will be described in more detail hereinafter, the unique type of fire detector 14 is provided with an asset tagging transponder. Assets such as indicated at 18.1 and 18.2 each have an asset tag 20 securely mounted therein or thereon. The asset tagging transponders are able to communicate in a wireless manner with the asset tags 20 within their communication range, by making use of a radio frequency (RF) transceiver, and are so able to detect the presence of a particular asset within their communication range. The asset tagging transponders have a relatively short range and can operate in a licence free frequency band. Each asset tag 20 is further provided with a tamper switch, whereby the asset tagging transponder can detect whether the asset tag has been tampered with, for example if an attempt has been made to remove the asset tag from the asset in question. In the case of an active asset tag having a battery power supply, the asset tagging transponder can be arranged to detect the status of the battery. Information about the presence (or absence) of a particular asset tag (and thus the asset to which it is affixed), whether the asset tag has been tampered with, and/or the battery status, as the case may be, is relayed to the fire panel 12 via the wire loop 16.

The infrastructure of an existing fire detection system, that is to say, the fire panel 12, the wire loop 16, and the sockets 17 in which the fire detectors 14 are receivable, can, in accordance with the invention, be used to provide for asset tagging or tracking at essentially no additional cost. All that is required is a special type of fire detector 14 which includes an asset tagging transponder, and suitable software installed on the fire panel.

The special type of fire detector may be provided in kit form, each kit comprising a fire detector and one or more asset tags associated with that fire detector.

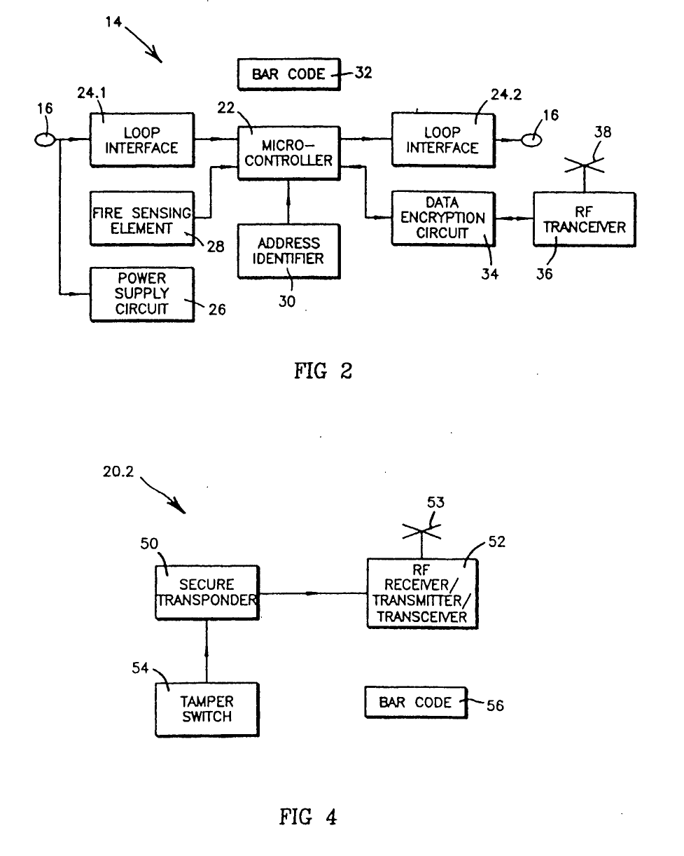

Referring now to FIG. 2, each fire detector 14 in accordance with the invention comprises a micro-controller 22, loop interfaces 24.1 and 24.2 for connecting the micro-controller into the wire loop 16, a power supply 26, a fire sensing element 28, and an address identifier 30, these being interconnected in the manner shown in the drawing. These components are found in conventional fire detectors (which are able to indicate the existence but not location of an alarm condition) and known analogue addressable fire detectors (which are able to indicate the existence and location of an alarm condition), and therefore do not need any further explanation. The fire sensing element 28 can be of the ionization, optical, gas, or heat type, or a combination thereof. The casing of the fire detector is provided with a bar code label 32, bearing a unique bar code for identifying the fire detector.

The fire detector 14 is further provided with a data encryption circuit 34 and an RF transceiver 36, which are connected to the micro-controller 22 in the manner shown in the drawing. The RF transceiver 36 has an antenna 38. It is to be understood that, instead of the data encryption circuit 34, data encryption may be provided for by software resident in the micro-controller 22.

Each asset tag 20 may either be an active asset tag 20.1 as is illustrated in FIG. 3, or a passive asset tag 20.2 as is illustrated in FIG. 4.

The active asset tag 20.1 (FIG. 3) comprises a secure (encryption enabled) micro-controller 40, a battery 42 for providing power to the electronics of the asset tag, an RF receiver, transmitter, or transceiver 44 having an antenna 45, and a tamper switch 46, these components being interconnected in the manner shown in the drawing. The casing of the asset tag 20.1 is provided with a bar code label 48, bearing a unique bar code for identifying the asset tag.

The passive asset tag 20.2 (FIG. 4) comprises a secure (encryption enabled) transponder 50, an RF receiver, transmitter, or transceiver 52 having an antenna 53, and a tamper switch 54. As with the active asset tag, the casing of the passive asset tag 20.2 is provided with a bar code label 56, bearing a unique bar code for identifying the asset tag.

The detectors 14 and asset tags 20 are conveniently supplied in kit form, each kit comprising a fire detector and one or more asset tags associated with the fire detector.

During manufacture, each detector 14 is programmed with details of the asset tags that it has to communicate with.

A customer who has acquired a set of fire detectors and asset tags will decide which assets are to be tagged or tracked. The asset tags 20 are then securely mounted in or on the individual assets. A hand-held bar code scanner is then used to scan each asset tag. The bar code information is captured by, for example, a suitably programmed lap-top computer. The software installed on the lap-top computer prompts the user to enter appropriate asset information (e.g. name of asset? location of asset? detector number?, and so on).

The detectors 14 will be scanned in a similar manner.

Once all the asset tags and detectors have been scanned and the data captured by the lap-top computer, the data is transferred to the fire panel 12 via a communications port. The fire panel may have a LAN type (WEB enabled) protocol in place, so that the asset activity will be accessible via the network.

In operation, each detector 14 is instructed by the fire panel 12 to enter an “accept devices” routine during the normal “accept devices” routine of the fire panel. During this operation each detector 14 communicates with each of the asset tags 20 to establish their presence. Once all the asset tags 20 have reported their presence, the detectors 14 will report back to the fire panel that the state of the various assets is healthy or functional.

The detectors 14 will, under control of the fire panel 12, interrogate each asset tag 20 associated therewith at regular intervals. If a tagged asset is moved beyond the communication range of the relevant detector, regular communication will fail and the detector will report an “asset missing” message to the fire panel via the wire loop 16. The fire panel will report this event in the manner which it was programmed to do by the customer.

Whilst it is preferred that the transponders be built into the fire detectors of the system, they can be dedicated devices connected to the communications network or can be built into detectors for conditions other than fires or can be built into isolators of the system or built into any other devices which form part of the system and are distributed in the building that the system protects.

1. A fire detection system which comprises a control panel, a plurality of distributed fire detectors, a communications network via which communication between the detectors and the control panel can take place, and an asset tagging transponder which is also linked to the control panel via said communications network.

2. A fire detector system as claimed in claim 1, wherein said asset tagging transponder is built in part of, or otherwise associated with, one of the fire detectors.

3. A fire detection system as claimed in claim 2, and which comprises a plurality of asset tagging transponders, each of said transponders being a built-in part of, or otherwise associated with, a corresponding one of the fire detectors.

4. A fire detection system as claimed in claim 1, and including a plurality of asset tags each of which includes means for establishing a radio frequency communications link with said transponder.

5. A fire detection system as claimed in claim 3, and including a plurality of asset tags each of which includes means for establishing a radio frequency communications link with at least one of said transponders.

6. A fire detection system as claimed in claim 5, wherein each asset tag includes means for establishing a radio frequency communications link with a plurality of said transponders whereby said transponders can track the location of the asset with which the tag is associated.

7. A fire detector which includes an asset tagging transponder.

8. A kit which comprises a fire detector including an asset tagging transponder, and one or more asset tags, the asset tagging transponder being capable of communicating with the (or each) asset tag over a radio frequency communications link.

9. A fire detection system which comprises a control panel, a plurality of fire detectors distributed in the building which is to be protected, each fire detector incorporating an asset tagging transponder, a hard wired communications link between the fire detectors and the control panel over which communications between the panel and detectors can take place, and a plurality of asset tags on assets distributed in said building, each asset tag being in radio frequency communication with one of said transponders.

10. A system as claimed in claim 9, wherein each asset tag include means for enabling it to communicate with two or more transponders whereby the transponders can track the location of assets in said premises.
